(19) United States
(12) Patent Application Publication
(10) Pub. No.: US 2025/0051216 A1
(43) Pub. Date: Feb. 13, 2025

(54) OPTICAL FIBER MANUFACTURING APPARATUS AND OPTICAL FIBER MANUFACTURING METHOD

(71) Applicant: SUMITOMO ELECTRIC INDUSTRIES, LTD., Osaka (JP)

(72) Inventor: Kazuhiro YONEZAWA, Tochigi (JP)

(21) Appl. No.: 18/798,059

(22) Filed: Aug. 8, 2024

(30) Foreign Application Priority Data
Aug. 10, 2023 (JP) 2023-130783

(51) Int. Cl. C03B 37/027; C03B 37/012

(52) U.S. Cl. CPC C03B 37/02718; C03B 37/01257; C03B 2205/57

(57) ABSTRACT

An optical fiber manufacturing apparatus includes: a drawing furnace configured to heat and fuse an optical fiber preform and draw the optical fiber preform to obtain a glass fiber; a cooling device configured to cool the glass fiber; and at least one preliminary chamber provided at an upper end of the cooling device. The optical fiber manufacturing apparatus further includes: a hydrogen gas supply device configured to supply hydrogen gas into the cooling device; and an inert gas supply device configured to supply inert gas into the at least one preliminary chamber.

### TECHNICAL FIELD

The present disclosure relates to an optical fiber manufacturing apparatus and an optical fiber manufacturing method. This application is based on and claims priority under 35 USC 119 from Japanese Patent Application No. 2023-130783 filed on Aug. 10, 2023, the contents of which are incorporated herein by reference.

### BACKGROUND ART

JP2000-103649A and JP2005-119901A disclose a drawing apparatus of an optical fiber in which a glass fiber drawn out of a drawing furnace is cooled by a cooling device supplied with helium (He) gas.

JPH06-157065A discloses a drawing apparatus of an optical fiber in which a glass fiber drawn out of a drawing furnace is cooled by a cooling device supplied with hydrogen gas.

### SUMMARY OF INVENTION

The present disclosure provides an optical fiber manufacturing apparatus including: a drawing furnace configured to heat and fuse an optical fiber preform and draw the optical fiber preform to obtain a glass fiber; a cooling device configured to cool the glass fiber; at least one preliminary chamber provided at an upper end of the cooling device; a hydrogen gas supply device configured to supply hydrogen gas into the cooling device; and an inert gas supply device configured to supply inert gas into the at least one preliminary chamber.

### BRIEF DESCRIPTION OF DRAWINGS

FIG. 1 is a schematic view showing a configuration of an optical fiber manufacturing apparatus according to a first embodiment.

FIG. 2 is a schematic view showing a configuration example of a preliminary chamber and a cooling device of the optical fiber manufacturing apparatus of FIG. 1.

FIG. 3 is a schematic view showing a configuration example of preliminary chambers and a cooling device of an optical fiber manufacturing apparatus according to Modification 1.

FIG. 4 is a schematic view showing a configuration example of a preliminary chamber and a cooling device of an optical fiber manufacturing apparatus according to Modification 2.

FIG. 5 is a schematic view showing a configuration example of a preliminary chamber and a cooling device of an optical fiber manufacturing apparatus according to Modification 3.

FIG. 6 is a schematic view showing a configuration of an optical fiber manufacturing apparatus according to a second embodiment.

FIG. 7 is a schematic view showing a configuration example of a cooling device of the optical fiber manufacturing apparatus of FIG. 6.

FIG. 8 is a schematic view showing a configuration example of a preliminary chamber and a cooling device of an optical fiber manufacturing apparatus according to Modification 4.

FIG. 9 is a schematic view showing a configuration example of a preliminary chamber and a cooling device of an optical fiber manufacturing apparatus according to Modification 5.

### DESCRIPTION OF EMBODIMENTS

In an optical fiber manufacturing apparatus, it has been studied to use the hydrogen gas which is easily available and has a high thermal conductivity instead of helium gas as inert gas for cooling the glass fiber. However, the hydrogen gas is combustible gas, an explosion concentration range of hydrogen in the atmosphere is 4 to 75%, and it is required to take measures against explosion.

An object of the present disclosure is to provide an optical fiber manufacturing apparatus and manufacturing method that prevent atmosphere from flowing into a cooling device that performs cooling using hydrogen gas.

According to the present disclosure, it is possible to provide the optical fiber manufacturing apparatus and manufacturing method that prevent atmosphere from flowing into the cooling device that performs cooling using the hydrogen gas.

### DESCRIPTION OF EMBODIMENTS OF PRESENT DISCLOSURE

First, embodiments of the present disclosure will be listed and described.

(1) An optical fiber manufacturing apparatus of the present disclosure includes: a drawing furnace configured to heat and fuse an optical fiber preform and draw the optical fiber preform to obtain a glass fiber; a cooling device configured to cool the glass fiber; at least one preliminary chamber provided at an upper end of the cooling device; a hydrogen gas supply device configured to supply hydrogen gas into the cooling device; and an inert gas supply device configured to supply inert gas into the at least one preliminary chamber.

According to the above configuration, since the glass fiber passes through the preliminary chamber supplied with the inert gas just before entering the cooling device, the atmosphere pulled by the glass fiber that travels at high speed and wrapped around the glass fiber is replaced with the inert gas in the preliminary chamber. Accordingly, the atmosphere can be prevented from flowing into the cooling device that performs cooling using the hydrogen gas.

The expression “provided at an upper end of the cooling device” in the present specification is not limited to a configuration in which the preliminary chamber is provided only at the upper end of the cooling device, but includes a configuration in which a part of the preliminary chamber is provided at the upper end of the cooling device.

(2) In the above (1) the at least one preliminary chamber may include a plurality of the preliminary chambers stacked on the upper end of the cooling device, and the inert gas supply device may be configured to supply the inert gas to each of the plurality of preliminary chambers.

According to the above configuration, it is possible to more reliably replace the atmosphere around the glass fiber with the inert gas by providing the plurality of preliminary chambers.

(3) In the above (1) or (2), the optical fiber manufacturing apparatus may further include: an oximeter configured to measure an oxygen concentration in the preliminary chamber.

According to the above configuration, an effect of replacing the atmosphere (oxygen) in the preliminary chamber with the inert gas can be confirmed by measuring the oxygen concentration in the preliminary chamber.

(4) In the above (3), the hydrogen gas supply device may be configured to stop supplying the hydrogen gas to the cooling device in response to a value of the oxygen concentration measured by the oximeter exceeding a predetermined value.

According to the above configuration, even when the oxygen concentration in the preliminary chamber increases, by stopping supplying the hydrogen gas to the cooling device, an explosion of the hydrogen gas due to the flow of atmosphere into the cooling device can be prevented.

(5) In any one of the above (1) to (4), the preliminary chamber may be configured to cover the cooling device entirely.

According to the above configuration, when the cooling device is formed in a double housing structure, an outer housing can be used as the preliminary chamber. Further, since the lower end of the cooling device is also covered with the preliminary chamber, the hydrogen gas pulled by the glass fiber that is delivered out from the cooling device can be replaced with the inert gas.

(6) An optical fiber manufacturing apparatus of the present disclosure includes: a drawing furnace configured to heat and fuse an optical fiber preform and draw the optical fiber preform to obtain a glass fiber; a cooling device configured to cool the glass fiber; a hydrogen gas supply device configured to supply hydrogen gas into the cooling device; and a hydrogen gas recovery device configured to recover the hydrogen gas supplied into the cooling device, in which a hydrogen gas recovery port for recovering the hydrogen gas in the cooling device is provided in a lower portion of the cooling device.

According to the above configuration, since the hydrogen gas is recovered from the vicinity of an opening from which the glass fiber of the cooling device is delivered out, the hydrogen gas pulled by the glass fiber that travels in the cooling device can be prevented from flowing out of the cooling device.

(7) In the above (6), the optical fiber manufacturing apparatus may further include: a preliminary chamber provided at an upper end of the cooling device; and an inert gas supply device configured to supply inert gas into the preliminary chamber.

According to the above configuration, since the glass fiber passes through the preliminary chamber supplied with the inert gas just before entering the cooling device, the atmosphere pulled by the glass fiber that travels at high speed and wrapped around the glass fiber is replaced with the inert gas in the preliminary chamber. Accordingly, the atmosphere can be prevented from flowing into the cooling device that performs cooling using the hydrogen gas.

(8) In the above (7), the preliminary chamber may be configured to cover the cooling device entirely.

According to the above configuration, when the cooling device is formed in a double housing structure, an outer housing can be used as the preliminary chamber. Further, since the lower end of the cooling device is also covered with the preliminary chamber, the hydrogen gas pulled by the glass fiber that is delivered out from the cooling device can be replaced with the inert gas.

(9) An optical fiber manufacturing method includes: heating and fusing an optical fiber preform and drawing the optical fiber preform to obtain a glass fiber; cooling the glass fiber by causing the glass fiber to pass through an inside of a cooling device into which hydrogen gas is supplied; and replacing, before the cooling the glass fiber, atmosphere around the glass fiber with inert gas by causing the glass fiber to pass through an inside of a preliminary chamber which is disposed at an upper end of the cooling device and into which the inert gas is supplied.

According to the above method, since the glass fiber passes through the preliminary chamber supplied with the inert gas just before entering the cooling device, the atmosphere pulled by the glass fiber that travels at high speed and wrapped around the glass fiber is replaced with the inert gas in the preliminary chamber. Accordingly, the atmosphere can be prevented from flowing into the cooling device that performs cooling using the hydrogen gas.

(10) An optical fiber manufacturing method includes: heating and fusing an optical fiber preform and drawing the optical fiber preform to obtain a glass fiber; cooling the glass fiber by causing the glass fiber to pass through an inside of a cooling device into which hydrogen gas is supplied; and recovering the hydrogen gas in the cooling device at a lower portion of the cooling device.

According to the above method, since the hydrogen gas is recovered from the vicinity of an opening from which the glass fiber of the cooling device is delivered out, the hydrogen gas pulled by the glass fiber that travels in the cooling device can be prevented from flowing out of the cooling device.

### DETAILS OF EMBODIMENTS OF PRESENT DISCLOSURE

Specific examples of an optical fiber manufacturing apparatus and an optical fiber manufacturing method according to embodiments of the present disclosure will be described below with reference to the drawings. The present invention is not limited to these exemplifications, but is indicated by the scope of claims, and is intended to include all modifications within a scope and meaning equivalent to the scope of claims. In the drawings used for the following description, the scale is appropriately changed to make members recognizable.

### First Embodiment

### Optical Fiber Manufacturing Apparatus 1

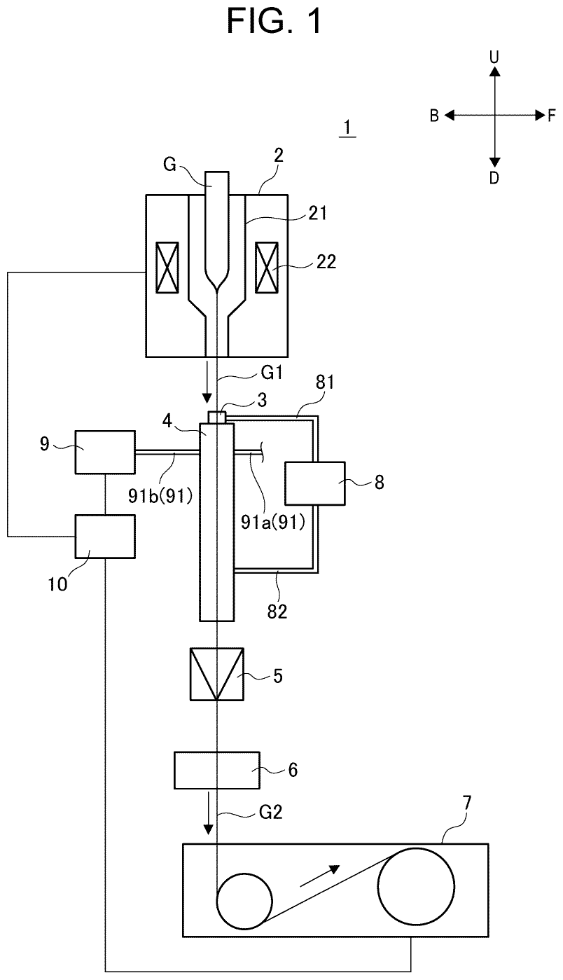

FIG. 1 is a schematic view showing a configuration of an optical fiber manufacturing apparatus 1 according to a first embodiment. As illustrated in FIG. 1, the optical fiber manufacturing apparatus 1 includes a drawing furnace 2, a preliminary chamber 3, a cooling device 4, a resin application device 5, a resin curing device 6, a winding device 7, an inert gas supply device 8, a hydrogen gas supply device 9, and a control device 10.

The drawing furnace 2 includes a furnace core tube 21 and a heater 22. An optical fiber preform G supplied into the furnace core tube 21 is heated and fused by the heater 22, and is drawn to continuously obtain a glass fiber G1 having a predetermined outer diameter.

The preliminary chamber 3 is provided at an upper end of the cooling device 4. Inert gas is supplied into the preliminary chamber 3 from the inert gas supply device 8 via a gas pipe 81. The glass fiber G1 drawn in the drawing furnace 2 passes through an inside of the preliminary chamber 3. When the glass fiber G1 passes through the preliminary chamber 3, an atmosphere wrapped around the glass fiber G1, which is pulled by the glass fiber G1, is replaced with the inert gas. Examples of the inert gas include argon gas and nitrogen gas.

The cooling device 4 is configured to cool the glass fiber G1. Hydrogen gas is supplied into the cooling device 4 from the hydrogen gas supply device 9 via a gas pipe 91. Although illustration of a part of a gas pipe 91a is omitted in FIG. 1, the gas pipe 91a is connected to the hydrogen gas supply device 9. The glass fiber G1 that has passed through the preliminary chamber 3 passes through an inside of the cooling device 4. The glass fiber G1 is cooled by the hydrogen gas while passing through the inside of the cooling device 4. Further, the inert gas is supplied into the cooling device 4 from the inert gas supply device 8 via a gas pipe 82. The inside of the cooling device 4 is positively pressurized with the inert gas.

The resin application device 5 is configured to apply a resin around the glass fiber G1. The resin curing device 6 is configured to cure the resin applied around the glass fiber G1. An optical fiber G2 on which the resin is cured is wound by the winding device 7.

The control device 10 controls an operation of each device. For example, the control device 10 adjusts a drawing speed of the glass fiber G1 by controlling the operations of the drawing furnace 2 and the winding device 7. For example, the control device 10 adjusts an amount of hydrogen gas supplied into the cooling device 4 by controlling the operation of the hydrogen gas supply device 9. The control device 10 includes, for example, a general-purpose computer including a general-purpose memory and a general-purpose microprocessor operating in cooperation with the general-purpose memory.

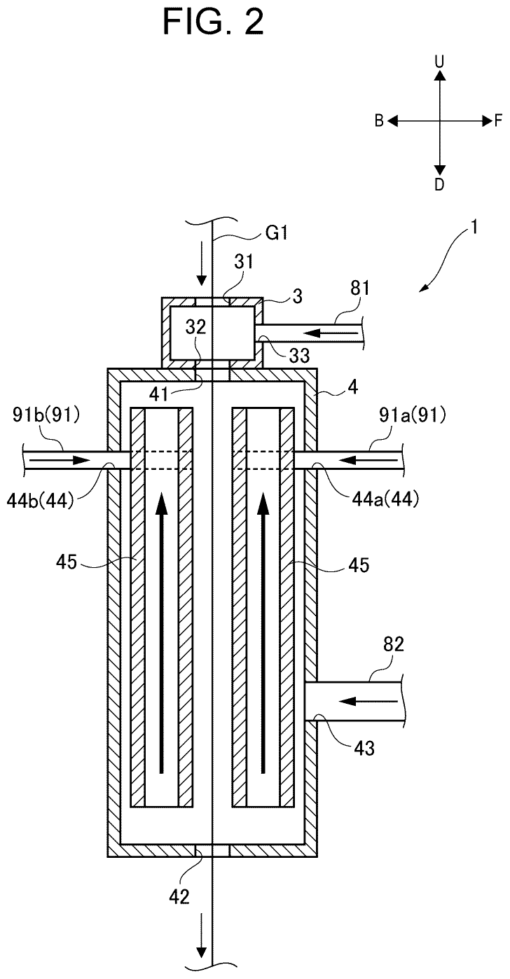

Next, configurations of the preliminary chamber 3 and the cooling device 4 will be described in detail with reference to FIG. 2.

As illustrated in FIG. 2, the preliminary chamber 3 is disposed at the upper end of the cooling device 4 in a state of being in contact with the upper end of the cooling device 4. A first opening 31 from which the glass fiber G1 is delivered in is provided at an upper end of the preliminary chamber 3. A second opening 32 from which the glass fiber G1 is delivered out is provided at a lower end of the preliminary chamber 3. The drawn glass fiber G1 enters the preliminary chamber 3 from the first opening 31, passes through the inside of the preliminary chamber 3, and is delivered out from the second opening 32.

A gas supply port 33 for supplying the inert gas is provided on a side surface of the preliminary chamber 3. One end of the gas pipe 81 is connected to the gas supply port 33. The inert gas supply device 8 is connected to the other end of the gas pipe 81 (see FIG. 1). The inert gas supplied from the inert gas supply device 8 is supplied into the preliminary chamber 3 from the gas supply port 33 through the gas pipe 81.

A first opening 41 from which the glass fiber G1 is delivered in is provided at the upper end of the cooling device 4. The first opening 41 is formed to communicate with the second opening 32 of the preliminary chamber 3. A second opening 42 from which the glass fiber G1 is delivered out is provided at a lower end of the cooling device 4. The glass fiber G1 that has passed through the preliminary chamber 3 enters the cooling device 4 from the first opening 41, passes through the inside of the cooling device 4, and is delivered out from the second opening 42.

A gas supply port 43 for supplying the inert gas is provided on a side surface of the cooling device 4. In this example, the gas supply port 43 is provided below a center in a longitudinal direction (upper-lower direction in the figure). One end of the gas pipe 82 is connected to the gas supply port 43. The inert gas supply device 8 is connected to the other end of the gas pipe 82 (see FIG. 1). The inert gas supplied from the inert gas supply device 8 is supplied into the preliminary chamber 3 from the gas supply port 43 through the gas pipe 82.

A gas supply port 44 for supplying the hydrogen gas is provided on a side surface of an upper portion of the cooling device 4. One end of the gas pipe 91 is connected to the gas supply port 44. The hydrogen gas supply device 9 is connected to the other end of the gas pipe 91 (see FIG. 1). The hydrogen gas supplied from the hydrogen gas supply device 9 is supplied from the gas supply port 44 into the cooling device 4 through the gas pipe 91. In this example, a gas supply port 44a and a gas supply port 44b are provided at positions facing each other, and the hydrogen gas supplied from the hydrogen gas supply device 9 passes through the gas pipe 91a and a gas pipe 91b and is supplied into the cooling device 4 from the gas supply port 44a and the gas supply port 44b. In this example, the gas pipe 91a and the gas pipe 91b extend inward of the gas supply port 44a and the gas supply port 44b, and supply the hydrogen gas to a position closer to the glass fiber G1.

The cooling device 4 has a cooling passage 45 therein. A cooling solvent flows into the cooling passage 45.

### Optical Fiber Manufacturing Method

Next, an optical fiber manufacturing method using the optical fiber manufacturing apparatus 1 will be described.

First, the optical fiber preform G is heated and fused and then drawn in the drawing furnace 2 (drawing step). Specifically, the optical fiber preform G is hung by a preform lifting mechanism (not shown) in the furnace core tube 21, and a lower portion of the optical fiber preform G is heated and fused by the heater 22. The fused optical fiber preform G is continuously drawn into the glass fiber G1 having a predetermined outer diameter due to the weight and tensile force of the fused glass.

The drawn glass fiber G1 passes continuously through the inside of the preliminary chamber 3 before passing through the inside of the cooling device 4. The inert gas is supplied from the inert gas supply device 8 into the preliminary chamber 3, and the atmosphere around the glass fiber G1 passing through the inside of the preliminary chamber 3 is replaced with the inert gas (replacement step). For example, by positively pressurizing the inside of the preliminary chamber 3 by the inert gas, the atmosphere pulled by the glass fiber G1 is prevented from flowing into the preliminary chamber 3.

The glass fiber G1 that has passed through the preliminary chamber 3 passes continuously through the inside of the cooling device 4. Since the cooling device 4 is provided at the lower end of the preliminary chamber 3, the glass fiber G1 that has passed through the inside of the preliminary chamber 3 is delivered into the cooling device 4 without being exposed to the atmosphere. The hydrogen gas is supplied into the cooling device 4 from the hydrogen gas supply device 9, and the glass fiber G1 that has passed through the inside of the cooling device 4 is cooled by the hydrogen gas (cooling step). In this example, the hydrogen gas is cooled by the cooling solvent flowing through the cooling passage 45, and the glass fiber G1 passing through the inside of the cooling device 4 is cooled by the cooled hydrogen gas.

Further, the inert gas is supplied from the inert gas supply device 8 to the inside of the cooling device 4, and the inside of the cooling device 4 is positively pressurized by the inert gas, so that the atmosphere pulled by the glass fiber G1 is prevented from flowing into the cooling device 4.

The resin is applied around the glass fiber G1 that has passed through the cooling device 4 by the resin application device 5. Subsequently, the resin applied around the glass fiber G1 is cured by the resin curing device 6 to form the optical fiber G2. The optical fiber G2 is wound by the winding device 7.

Here, the hydrogen gas used as the refrigerant gas of the cooling device 4 is more easily available than the helium gas. Further, since the hydrogen gas has a higher thermal conductivity than the helium gas, the hydrogen gas can efficiently cool the glass fiber G1. Accordingly, even when the drawing speed of the glass fiber G1 is high, the glass fiber G1 can be sufficiently cooled, thereby improving the productivity of the optical fiber G2. On the other hand, the hydrogen gas is combustible gas, and the hydrogen gas explodes when mixed with atmosphere (oxygen) having a concentration equal to or higher than a certain value.

According to the optical fiber manufacturing apparatus 1 and the optical fiber manufacturing method of the first embodiment, since the glass fiber G1 passes through the preliminary chamber 3 supplied with the inert gas just before entering the cooling device 4, the atmosphere pulled by the glass fiber G1 that travels at high speed and wrapped around the glass fiber G1 is replaced with the inert gas in the preliminary chamber 3. Accordingly, the atmosphere can be prevented from flowing into the cooling device 4 supplied with the hydrogen gas.

Further, in the present embodiment, since the inert gas is supplied to the inside of the cooling device 4, the inside of the cooling device 4 is positively pressurized, and the atmosphere pulled by the glass fiber G1 can be further prevented from flowing into the cooling device 4. The hydrogen gas is diluted with the inert gas in the cooling device 4 and discharged from the second opening 42. Flow rates of the inert gas and the hydrogen gas supplied into the cooling device 4 are set such that the hydrogen gas does not explode even when mixed with the atmosphere.

Incidentally, in the present embodiment, the inside of the preliminary chamber 3 is positively pressurized by the inert gas, so that the atmosphere pulled by the glass fiber G1 is prevented from flowing into the preliminary chamber 3. However, for example, a gas exhaust port (not shown) may be provided in the preliminary chamber 3, and the atmosphere pulled by the glass fiber G1 and flowing into the preliminary chamber 3 may be pushed out by the inert gas and discharged from the gas exhaust port.

### Modification 1

In the first embodiment, one preliminary chamber 3 is disposed at an upper end of the cooling device 4. However, a plurality of the preliminary chambers 3 may be stacked on the upper end of the cooling device 4.

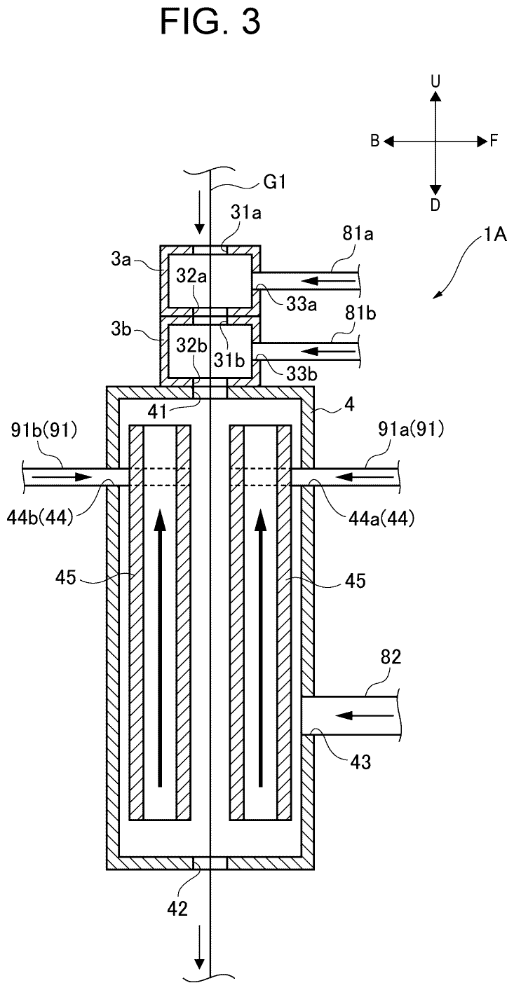

FIG. 3 shows a configuration example of an optical fiber manufacturing apparatus 1A according to Modification 1. The optical fiber manufacturing apparatus 1A according to Modification 1 differs from the optical fiber manufacturing apparatus 1 shown in FIG. 2 in the configuration of the preliminary chamber 3. Members having the same reference numerals as those members already described in description of the first embodiment will not be described for convenience of description.

As illustrated in FIG. 3, in the optical fiber manufacturing apparatus 1A according to Modification 1, two preliminary chambers 3a and 3b are stacked and disposed at the upper end of the cooling device 4. Specifically, the preliminary chamber 3b is disposed at the upper end of the cooling device 4, and the preliminary chamber 3a is disposed at an upper end of the preliminary chamber 3b.

A first opening 31a from which the glass fiber G1 is delivered in is provided at an upper end of the preliminary chamber 3a. A second opening 32a from which the glass fiber G1 is delivered out is provided at a lower end of the preliminary chamber 3a. A gas supply port 33a for supplying inert gas is provided on a side surface of the preliminary chamber 3a. One end of a gas pipe 81a is connected to the gas supply port 33a. The inert gas supply device 8 is connected to the other end of the gas pipe 81a (see FIG. 1). The inert gas supplied from the inert gas supply device 8 is supplied into the preliminary chamber 3a from the gas supply port 33a through the gas pipe 81a.

A first opening 31b from which the glass fiber G1 is delivered in is provided at the upper end of the preliminary chamber 3b. The first opening 31b is formed to communicate with the second opening 32a of the preliminary chamber 3a. A second opening 32b from which the glass fiber G1 is delivered out is provided at a lower end of the preliminary chamber 3b. The second opening 32b is formed to communicate with the first opening 41 of the cooling device 4. A gas supply port 33b for supplying the inert gas is provided on a side surface of the preliminary chamber 3b. One end of a gas pipe 81b is connected to the gas supply port 33b. The inert gas supply device 8 is connected to the other end of the gas pipe 81b (see FIG. 1). The inert gas supplied from the inert gas supply device 8 is supplied into the preliminary chamber 3b from the gas supply port 33b through the gas pipe 81b.

The glass fiber G1 drawn from the drawing furnace 2 passes continuously through an inside of the preliminary chamber 3a and an inside of the preliminary chamber 3b before passing through an inside of the cooling device 4. The inert gas is supplied from the inert gas supply device 8 into the preliminary chamber 3a, and atmosphere around the glass fiber G1 passing through the inside of the preliminary chamber 3a is replaced with the inert gas.

Further, the inert gas is supplied from the inert gas supply device 8 into the preliminary chamber 3b, and atmosphere around the glass fiber G1 passing through the inside of the preliminary chamber 3b is replaced with the inert gas.

According to the optical fiber manufacturing apparatus 1A of Modification 1 since the glass fiber G1 passes through the two preliminary chambers 3a and 3b supplied with the inert gas just before entering the cooling device 4, the atmosphere around the glass fiber G1 can be more reliably replaced with the inert gas.

In the present modification, a gas exhaust port (not shown) may be provided in each of the preliminary chamber 3a and the preliminary chamber 3b, and the atmosphere pulled by the glass fiber G1 and flowing into the preliminary chambers 3a and 3b may be pushed out by the inert gas and discharged from the gas exhaust port.

In the present modification, three or more preliminary chambers 3 may be stacked on the upper end of the cooling device 4.

### Modification 2

In the first embodiment, the preliminary chamber 3 is provided only at the upper end of the cooling device 4. However, the preliminary chamber 3 may be provided so as to cover the entire cooling device 4 including the side surface and the lower end of the cooling device 4 in addition to the upper end of the cooling device 4.

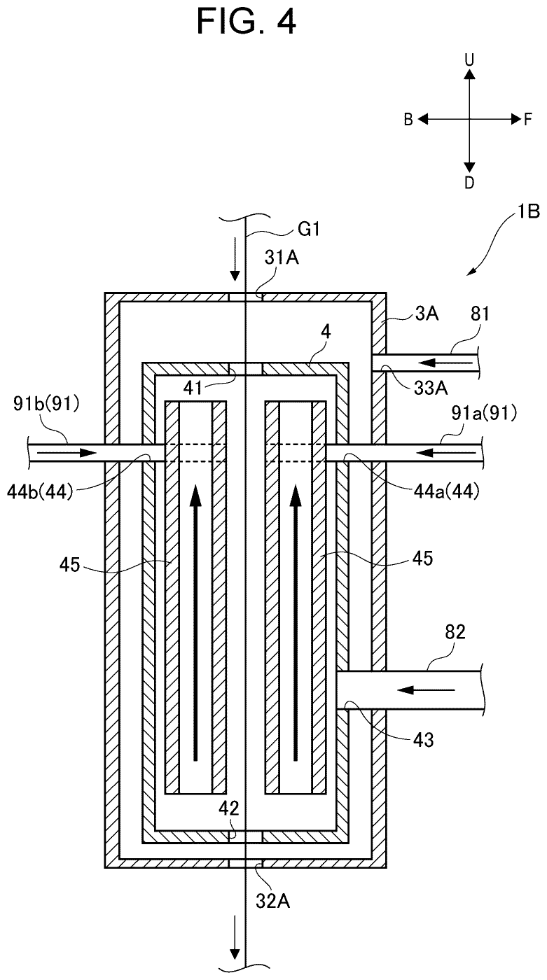

FIG. 4 shows a configuration example of an optical fiber manufacturing apparatus 1B according to Modification 2. The optical fiber manufacturing apparatus 1B according to Modification 2 differs from the optical fiber manufacturing apparatus 1 shown in FIG. 2 in the configuration of the preliminary chamber 3. Members having the same reference numerals as those members already described in description of the first embodiment will not be described for convenience of description.

As illustrated in FIG. 4, the optical fiber manufacturing apparatus 1B according to Modification 2 includes a preliminary chamber 3A configured to cover the entire cooling device 4.

A first opening 31A from which the glass fiber G1 is delivered in is provided at an upper end of the preliminary chamber 3A. A second opening 32A from which the glass fiber G1 is delivered out is provided at a lower end of the preliminary chamber 3A. A gas supply port 33A for supplying inert gas is provided on a side surface of the preliminary chamber 3A. One end of the gas pipe 81 is connected to the gas supply port 33A. The inert gas supply device 8 is connected to the other end of the gas pipe 81 (see FIG. 1). The inert gas supplied from the inert gas supply device 8 is supplied into the preliminary chamber 3A from the gas supply port 33A through the gas pipe 81.

The glass fiber G1 drawn from the drawing furnace 2 enters the preliminary chamber 3A before passing through the inside of the cooling device 4. The inert gas is supplied from the inert gas supply device 8 into the preliminary chamber 3A, and atmosphere around the glass fiber G1 passing through an inside of the preliminary chamber 3A is replaced with the inert gas. For example, by positively pressurizing the inside of the preliminary chamber 3A by the inert gas, the atmosphere pulled by the glass fiber G1 is prevented from flowing into the preliminary chamber 3A.

The glass fiber G1 that has passed through an upper portion of the preliminary chamber 3A passes continuously through the inside of the cooling device 4. Since the preliminary chamber 3A is provided to cover the entire cooling device 4, the glass fiber G1 passes through the inside of the cooling device 4 without being exposed to the atmosphere. Hydrogen gas is supplied into the cooling device 4 from the hydrogen gas supply device 9, and the glass fiber G1 that has passed through the inside of the cooling device 4 is cooled by the hydrogen gas.

The glass fiber G1 that has passed through the cooling device 4 passes through the inside of the preliminary chamber 3A again. Since the inert gas is supplied from the inert gas supply device 8 into the preliminary chamber 3A, the hydrogen gas pulled by the glass fiber G1 that is delivered out from the second opening 42 of the cooling device 4 is replaced with the inert gas. For example, by positively pressurizing the inside of the preliminary chamber 3A by the inert gas, the hydrogen gas pulled by the glass fiber G1 is prevented from flowing to the outside of the cooling device 4. The hydrogen gas is diluted with the inert gas in the cooling device 4, further diluted with inert gas in the preliminary chamber 3A, and then discharged from the first opening 31A or the second opening 32A. Since the hydrogen gas is sufficiently diluted with the inert gas and then discharged from the preliminary chamber 3A, the hydrogen gas does not explode when mixed with the atmosphere.

According to the optical fiber manufacturing apparatus 1B according to Modification 2, when the cooling device 4 is formed in a double housing structure, an outer housing can be used as the preliminary chamber 3A. Further, since the lower end of the cooling device 4 is also covered with the preliminary chamber 3A, the hydrogen gas pulled by the glass fiber G1 that is delivered out from the cooling device 4 can be replaced with the inert gas.

### Modification 3

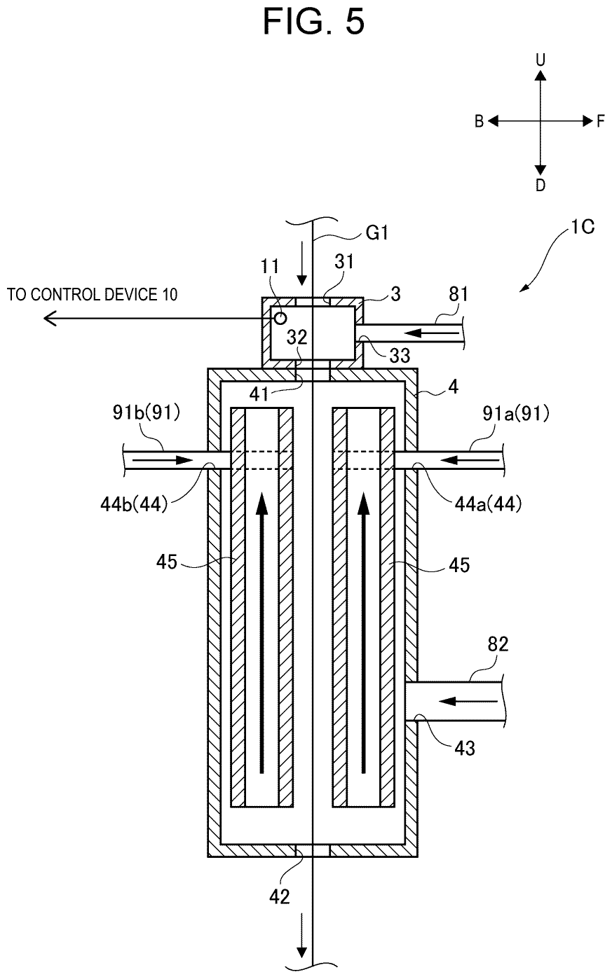

FIG. 5 shows a configuration example of an optical fiber manufacturing apparatus 1C according to Modification 3. The optical fiber manufacturing apparatus 1C according to Modification 3 has a configuration in which an oximeter 11 is added to the optical fiber manufacturing apparatus 1 shown in FIG. 2. Members having the same reference numerals as those members already described in description of the first embodiment will not be described for convenience of description.

As illustrated in FIG. 5, in the optical fiber manufacturing apparatus 1C according to Modification 3, the oximeter 11 is disposed inside the preliminary chamber 3. The oximeter 11 is configured to measure an oxygen concentration in the preliminary chamber 3. The hydrogen gas supply device 9 is configured to stop supplying hydrogen gas to the cooling device 4 when a measured value of the oxygen concentration by the oximeter 11 exceeds a predetermined value.

Specifically, the oximeter 11 outputs information on the measured oxygen concentration value to the control device 10. When the control device 10 determines that the oxygen concentration value in the preliminary chamber 3, which is acquired from the oximeter 11, exceeds the predetermined value, the control device 10 outputs, to the hydrogen gas supply device 9, a control signal for stopping supplying the hydrogen gas to the cooling device 4. The hydrogen gas supply device 9 stops supplying the hydrogen gas to the cooling device 4 based on the control signal.

According to the optical fiber manufacturing apparatus 1C of Modification 3, an effect of replacing the atmosphere (oxygen) in the preliminary chamber 3 with the inert gas can be confirmed by measuring the oxygen concentration in the preliminary chamber 3.

Further, even when the oxygen concentration in the preliminary chamber 3 increases, by stopping supplying the hydrogen gas to the cooling device 4, an explosion of the hydrogen gas due to the flow of atmosphere into the cooling device 4 can be prevented.

### Second Embodiment

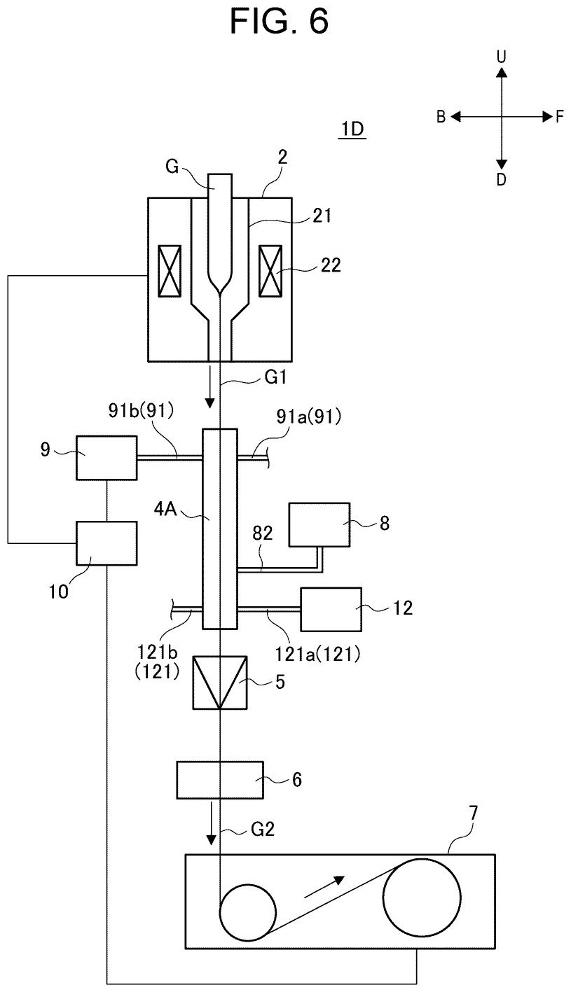

Next, an optical fiber manufacturing apparatus 1D according to a second embodiment will be described with reference to FIG. 6. Members having the same reference numerals as those members already described in description of the first embodiment will not be described for convenience of description.

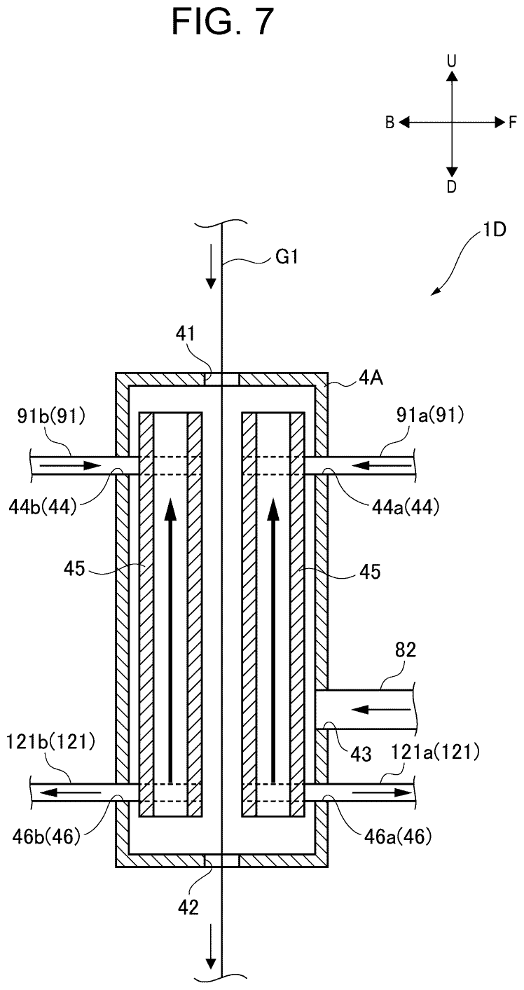

FIG. 6 shows a configuration example of the optical fiber manufacturing apparatus 1D according to the second embodiment. FIG. 7 shows a configuration of a cooling device 4A of the optical fiber manufacturing apparatus 1D.

As illustrated in FIG. 6, the optical fiber manufacturing apparatus 1D includes the drawing furnace 2, the cooling device 4A, the resin application device 5, the resin curing device 6, the winding device 7, the inert gas supply device 8, the hydrogen gas supply device 9, the control device 10, and a hydrogen gas recovery device 12.

The glass fiber G1 drawn in the drawing furnace 2 passes through the inside of the cooling device 4A. Hydrogen gas is supplied into the cooling device 4A from the hydrogen gas supply device 9 via the gas pipe 91. The glass fiber G1 is cooled by the hydrogen gas while passing through the inside of the cooling device 4A. Further, the inert gas is supplied into the cooling device 4A from the inert gas supply device 8 via the gas pipe 82. The inside of the cooling device 4A is positively pressurized with the inert gas.

As illustrated in FIG. 7, a gas recovery port 46 for recovering the hydrogen gas is provided on a side surface of a lower portion of the cooling device 4A. One end of a gas pipe 121 is connected to the gas recovery port 46. The hydrogen gas recovery device 12 is connected to the other end of the gas pipe 121 (see FIG. 6). Mixed gas containing the hydrogen gas and the inert gas supplied into the cooling device 4A is suctioned from the gas recovery port 46 and recovered in the hydrogen gas recovery device 12. In this example, a gas recovery port 46a and a gas recovery port 46b are provided at positions facing each other, and the mixed gas suctioned from the gas recovery port 46a and the gas recovery port 46b is recovered in the hydrogen gas recovery device 12 through a gas pipe 121a and a gas pipe 121b. Although illustration of a part of the gas pipe 121b is omitted in FIG. 6, the gas pipe 121b is connected to the hydrogen gas recovery device 12. Further, in this example, the gas pipe 121a and the gas pipe 121b extend to the inside of the gas recovery port 46a and the gas recovery port 46b, respectively, and recover the hydrogen gas at a position closer to the glass fiber G1.

In an optical fiber manufacturing method using the optical fiber manufacturing apparatus 1D, first, the optical fiber preform G is heated and fused and then drawn in the drawing furnace 2 (drawing step).

The glass fiber G1 drawn in the drawing furnace 2 passes continuously through the inside of the cooling device 4A. The hydrogen gas is supplied into the cooling device 4A from the hydrogen gas supply device 9, and the glass fiber G1 that has passed through the inside of the cooling device 4A is cooled by the hydrogen gas (cooling step). In this example, the hydrogen gas is cooled by the cooling solvent flowing through the cooling passage 45, and the glass fiber G1 passing through the inside of the cooling device 4A is cooled by the cooled hydrogen gas.

Further, the inert gas is supplied from the inert gas supply device 8 to the inside of the cooling device 4A, and the inside of the cooling device 4A is positively pressurized by the inert gas, so that the atmosphere pulled by the glass fiber G1 is prevented from flowing into the cooling device 4A.

In the lower portion of the cooling device 4A, the mixed gas containing the hydrogen gas and the inert gas in the cooling device 4A is suctioned from the gas recovery port 46, and the suctioned mixed gas is recovered in the hydrogen gas recovery device 12 through the gas pipe 121 (recovery step).

According to the optical fiber manufacturing apparatus 1D and the optical fiber manufacturing method according to the second embodiment, since the hydrogen gas is recovered in front of the second opening 42 of the cooling device 4A, the hydrogen gas pulled by the glass fiber G1 that travels in the cooling device 4A can be prevented from flowing out of the cooling device 4A.

The hydrogen gas recovery device 12 may be configured to separate and purify the hydrogen gas from the mixed gas suctioned from the gas recovery port 46 to regenerate the hydrogen gas to a reusable state. The hydrogen gas recovery device 12 and the hydrogen gas supply device 9 may be connected by a pipe (not shown), and the hydrogen gas recovered by the hydrogen gas recovery device 12 may be supplied to the hydrogen gas supply device 9.

### Modification 4

In the second embodiment, the optical fiber manufacturing apparatus 1D may include one or more preliminary chambers 3 disposed at an upper end of the cooling device 4A, like the optical fiber manufacturing apparatus 1 according to the first embodiment.

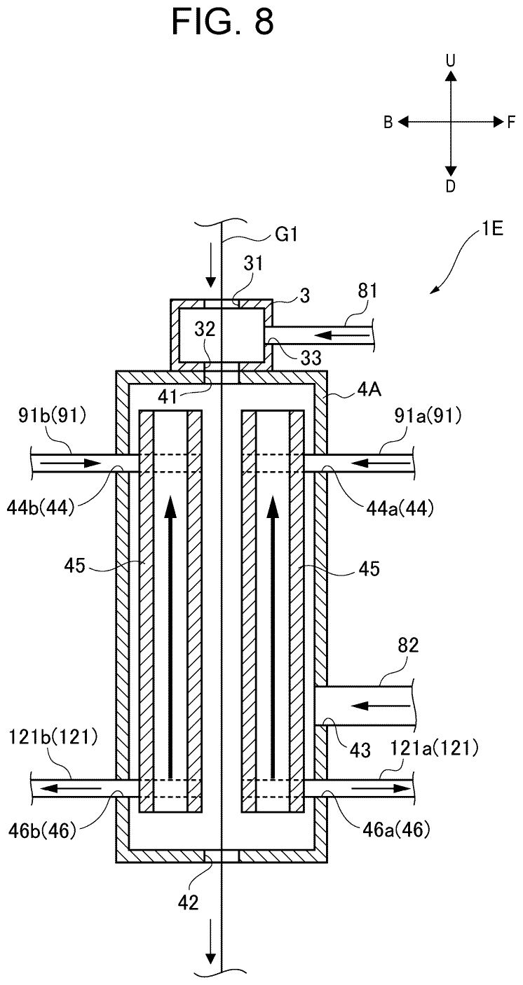

FIG. 8 shows a configuration example of an optical fiber manufacturing apparatus 1E according to Modification 4. The optical fiber manufacturing apparatus 1E according to Modification 4 has the configuration in which the preliminary chamber 3 is added to the optical fiber manufacturing apparatus 1D shown in FIG. 7. Members having the same reference numerals as those members already described in description of the first and second embodiments will not be described for convenience of description.

As illustrated in FIG. 8, the optical fiber manufacturing apparatus 1E includes the preliminary chamber 3 provided at the upper end of the cooling device 4A. The preliminary chamber 3 is disposed at the upper end of the cooling device 4A in a state of being in contact with the upper end of the cooling device 4A. The first opening 31 from which the glass fiber G1 is delivered in is provided at an upper end of the preliminary chamber 3. The second opening 32 from which the glass fiber G1 is delivered out is provided at a lower end of the preliminary chamber 3. The drawn glass fiber G1 enters the preliminary chamber 3 from the first opening 31, passes through the inside of the preliminary chamber 3, and is delivered out from the second opening 32.

The gas supply port 33 for supplying the inert gas is provided on a side surface of the preliminary chamber 3. Examples of the inert gas include argon gas and nitrogen gas. One end of the gas pipe 81 is connected to the gas supply port 33. The inert gas supply device 8 is connected to the other end of the gas pipe 81 (see FIG. 6). The inert gas supplied from the inert gas supply device 8 is supplied into the preliminary chamber 3 from the gas supply port 33 through the gas pipe 81.

The glass fiber G1 drawn in the drawing furnace 2 passes continuously through the inside of the preliminary chamber 3 before passing through the inside of the cooling device 4A. The inert gas is supplied from the inert gas supply device 8 into the preliminary chamber 3, and the atmosphere around the glass fiber G1 passing through the inside of the preliminary chamber 3 is replaced with the inert gas (replacement step). For example, by positively pressurizing the inside of the preliminary chamber 3 of the cooling device 4A by the inert gas, the atmosphere pulled by the glass fiber G1 is prevented from flowing into the preliminary chamber 3.

The glass fiber G1 that has passed through the preliminary chamber 3 passes continuously through the inside of the cooling device 4A. Since the cooling device 4A is provided at the lower end of the preliminary chamber 3, the glass fiber G1 that has passed through the inside of the preliminary chamber 3 is delivered into the cooling device 4A without being exposed to the atmosphere. The hydrogen gas is supplied into the cooling device 4A from the hydrogen gas supply device 9, and the glass fiber G1 that has passed through the inside of the cooling device 4A is cooled by the hydrogen gas (cooling step). In this example, the hydrogen gas is cooled by the cooling solvent flowing through the cooling passage 45, and the glass fiber G1 passing through the inside of the cooling device 4A is cooled by the cooled hydrogen gas.

According to the optical fiber manufacturing apparatus 1E and the optical fiber manufacturing method of Modification 4, since the glass fiber G1 passes through the preliminary chamber 3 supplied with the inert gas just before entering the cooling device 4A, the atmosphere pulled by the glass fiber G1 that travels at high speed and wrapped around the glass fiber G1 is replaced with the inert gas in the preliminary chamber 3. Accordingly, the atmosphere can be prevented from flowing into the cooling device 4A that performs cooling using the hydrogen gas.

### Modification 5

In Modification 4, the preliminary chamber 3 is provided only at an upper end of the cooling device 4A, but the preliminary chamber 3 may be provided to cover the entire cooling device 4A including a side surface and a lower end of the cooling device 4A in addition to the upper end of the cooling device 4A.

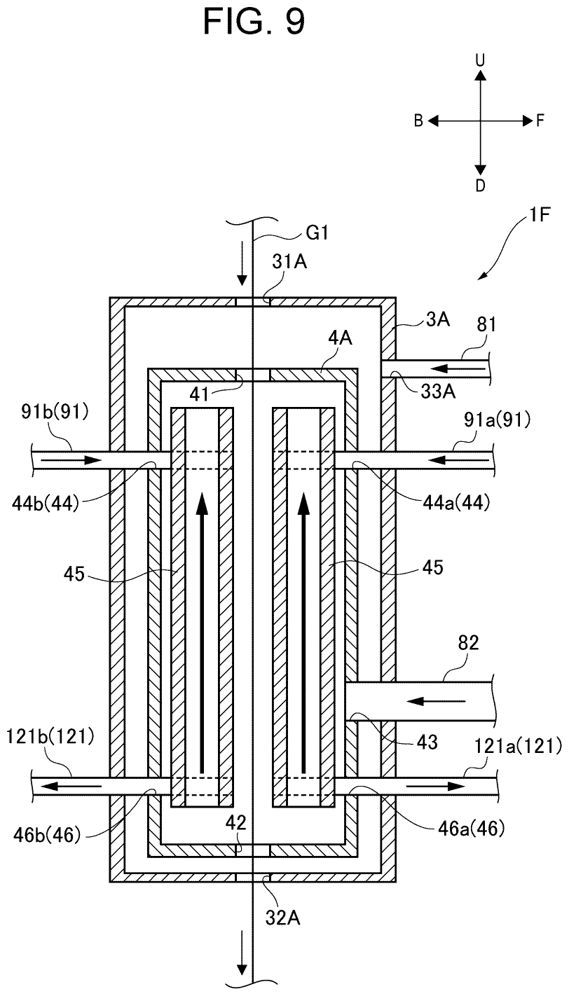

FIG. 9 shows a configuration example of an optical fiber manufacturing apparatus 1F according to Modification 5. The optical fiber manufacturing apparatus 1F according to Modification 5 differs from the optical fiber manufacturing apparatus 1E shown in FIG. 8 in the configuration of the preliminary chamber 3. Members having the same reference numerals as those members already described in description of Modification 2 and Modification 4 will not be described for convenience of description.

As illustrated in FIG. 9, the optical fiber manufacturing apparatus 1F according to Modification 5 includes the preliminary chamber 3A configured to cover the entire cooling device 4A.

The first opening 31A from which the glass fiber G1 is delivered in is provided at an upper end of the preliminary chamber 3A. The second opening 32A from which the glass fiber G1 is delivered out is provided at a lower end of the preliminary chamber 3A. The gas supply port 33A for supplying inert gas is provided on a side surface of the preliminary chamber 3A. One end of the gas pipe 81 is connected to the gas supply port 33A. The inert gas supply device 8 is connected to the other end of the gas pipe 81 (see FIG. 6). The inert gas supplied from the inert gas supply device 8 is supplied into the preliminary chamber 3A from the gas supply port 33A through the gas pipe 81.

The glass fiber G1 drawn from the drawing furnace 2 enters the preliminary chamber 3A before passing through the inside of the cooling device 4A. The inert gas is supplied from the inert gas supply device 8 into the preliminary chamber 3A, and atmosphere around the glass fiber G1 passing through an upper portion of the preliminary chamber 3A is replaced with the inert gas. For example, by positively pressurizing the inside of the preliminary chamber 3A by the inert gas, the atmosphere pulled by the glass fiber G1 is prevented from flowing into the preliminary chamber 3A.

The glass fiber G1 that has passed through the upper portion of the preliminary chamber 3A passes continuously through the inside of the cooling device 4A. Since the preliminary chamber 3A is provided to cover the entire cooling device 4A, the glass fiber G1 passes through the inside of the cooling device 4A without being exposed to the atmosphere. Hydrogen gas is supplied into the cooling device 4A from the hydrogen gas supply device 9, and the glass fiber G1 that has passed through the inside of the cooling device 4A is cooled by the hydrogen gas.

The glass fiber G1 that has passed through the cooling device 4A passes through the inside of the preliminary chamber 3A again. Since the inert gas is supplied from the inert gas supply device 8 into the preliminary chamber 3A, the hydrogen gas pulled by the glass fiber G1 that is delivered out from the second opening 42 of the cooling device 4A is replaced with the inert gas. For example, by positively pressurizing the inside of the preliminary chamber 3A by the inert gas, the hydrogen gas pulled by the glass fiber G1 is prevented from flowing to the outside of the cooling device 4A.

According to the optical fiber manufacturing apparatus 1F according to Modification 5, when the cooling device 4A is formed in a double housing structure, an outer housing can be used as the preliminary chamber 3A. Further, since a lower end of the cooling device 4A is also covered with the preliminary chamber 3A, the hydrogen gas pulled by the glass fiber G1 that is delivered out from the second opening 42 of the cooling device 4A can be replaced with the inert gas.

Although the present disclosure has been described in detail with reference to the specific embodiments, it is apparent to those skilled in the art that various changes and modifications can be made without departing from the spirit and scope of the present disclosure. In addition, the number, positions, shapes, and the like of the constituent members described above are not limited to those in the above embodiments, and can be changed to the numbers, positions, shapes, and the like suitable for carrying out the present disclosure.

What is claimed is:

1. An optical fiber manufacturing apparatus comprising:
a drawing furnace configured to heat and fuse an optical fiber preform and draw the optical fiber preform to obtain a glass fiber;
a cooling device configured to cool the glass fiber;
at least one preliminary chamber provided at an upper end of the cooling device;
a hydrogen gas supply device configured to supply hydrogen gas into the cooling device; and
an inert gas supply device configured to supply inert gas into the at least one preliminary chamber.

2. The optical fiber manufacturing apparatus according to claim 1,
wherein the at least one preliminary chamber comprises a plurality of the preliminary chambers stacked on the upper end of the cooling device, and
wherein the inert gas supply device is configured to supply the inert gas to each of the plurality of preliminary chambers.

3. The optical fiber manufacturing apparatus according to claim 1, further comprising:
an oximeter configured to measure an oxygen concentration in the preliminary chamber.

4. The optical fiber manufacturing apparatus according to claim 3,
wherein the hydrogen gas supply device is configured to stop a supply of the hydrogen gas to the cooling device in response to a value of the oxygen concentration measured by the oximeter exceeding a predetermined value.

5. The optical fiber manufacturing apparatus according to claim 1,
wherein the preliminary chamber is configured to cover the cooling device entirely.

6. An optical fiber manufacturing apparatus comprising:
a drawing furnace configured to heat and fuse an optical fiber preform and draw the optical fiber preform to obtain a glass fiber;
a cooling device configured to cool the glass fiber;
a hydrogen gas supply device configured to supply hydrogen gas into the cooling device; and
a hydrogen gas recovery device configured to recover the hydrogen gas supplied into the cooling device,
wherein a hydrogen gas recovery port for recovering the hydrogen gas in the cooling device is provided in a lower portion of the cooling device.

7. The optical fiber manufacturing apparatus according to claim 6, further comprising:
a preliminary chamber provided at an upper end of the cooling device; and
an inert gas supply device configured to supply inert gas into the preliminary chamber.

8. The optical fiber manufacturing apparatus according to claim 7,
wherein the preliminary chamber is configured to cover the cooling device entirely.

9. An optical fiber manufacturing method comprising:
heating and fusing an optical fiber preform and drawing the optical fiber preform to obtain a glass fiber;
cooling the glass fiber by causing the glass fiber to pass through an inside of a cooling device into which hydrogen gas is supplied; and
replacing, before the cooling the glass fiber, atmosphere around the glass fiber with inert gas by causing the glass fiber to pass through an inside of a preliminary chamber which is disposed at an upper end of the cooling device and into which the inert gas is supplied.

10. An optical fiber manufacturing method comprising:
heating and fusing an optical fiber preform and drawing the optical fiber preform to obtain a glass fiber;
cooling the glass fiber by causing the glass fiber to pass through an inside of a cooling device into which hydrogen gas is supplied; and
recovering the hydrogen gas in the cooling device at a lower portion of the cooling device.
